(19) United States
(12) Patent Application Publication
(10) Pub. No.: US 2025/0315692 A1
(43) Pub. Date: Oct. 9, 2025

(54) METHOD AND SYSTEM FOR ENABLING CONTINUOUS MACHINE LEARNING USING DOMAIN-SPECIFIC LEARNING PROCESSES

(71) Applicant: Patepojat Oy, Mäntsälä (FI)

(72) Inventors: Aarne Ylä-Rotiala, Mäntsälä (FI); Antti Kokkinen, Espoo (FI); Harri T Okkonen, Heinola (FI)

(21) Appl. No.: 18/984,169

(22) Filed: Dec. 17, 2024

Related U.S. Application Data
(60) Provisional application No. 63/631,463, filed on Apr. 9, 2024.

(51) Int. Cl. G06N 5/02

(52) U.S. Cl. CPC G06N 5/02

(57) ABSTRACT

A method and system for continuous machine learning is disclosed. A set of domain-specific learning processes (LPs) from an external repository are obtained. Each LP of the domain-specific LPs is associated with at least one domain-specific knowledge graph representing learned parameters, patterns, and processing capabilities. Operational data from multiple sources is received and pattern representation is generated. One or more relevant LPs from the set of domain-specific LPs are identified by matching the pattern representation with at least one knowledge graph. The identified one or more LPs are executed to generate execution results and are validated through a contradiction resolution upon detecting the existence of contradictions between execution results and existing domain knowledge during the execution. The one or more LPs and their associated domain-specific knowledge graphs, trust relationships between LPs are updated based on validation outcomes and are submitted to the external repository.

### CROSS-REFERENCE TO PRIOR APPLICATION

This application claims the benefit of and priority to U.S. Provisional Application No. 63/631,463, filed on Apr. 9, 2024, which is hereby incorporated herein by reference in its entirety.

The entire contents of the priority application, including any appendices, exhibits, and amendments filed therewith, are hereby incorporated by reference in its entirety.

### FIELD

Various embodiments of the disclosure relate to continuous machine learning systems. More particularly, the disclosure relates to a system and method for continuous machine learning using domain-specific learning processes obtained from an external repository, wherein the learning processes utilize knowledge graphs and trust-based knowledge exchange for continuous evolution.

### BACKGROUND

The field of Artificial Intelligence (AI) is evolving rapidly, demonstrating significant advancements across various industries and applications. However, this unprecedented growth also brings about unique challenges, particularly in developing modular and reusable learning components that can be validated and shared across systems. Current systems lack standardized mechanisms for managing distributed learning processes and validating knowledge exchange between them, especially when such processes are influenced by diverse sources, origins, and consolidated external inputs.

In parallel with ensuring the integrity of learning processes within AI applications, there is an increasing demand for regulatory bodies to establish comprehensive rules and governance structures. The regulations are essential to mitigate risks and ensure that AI-driven outcomes align with societal values and ethical considerations. Protecting individuals and communities affected by AI operations is becoming a critical concern, requiring oversight mechanisms that balance innovation with accountability.

Existing solutions fall short in empowering AI systems to leverage continuous learning effectively, particularly in modular architectures where different learning processes need to collaborate and share knowledge while maintaining trust relationships. The shortcomings become especially apparent in scenarios involving incorrect or questionable data. Current methodologies often lack the adaptability and robustness needed to discern, adapt to, or rectify inaccuracies in data inputs, which are critical for maintaining the reliability and relevance of AI outputs.

In addition to failing to benefit stakeholders within their chosen domains, existing solutions also fall short in enabling AI systems to utilize continuous learning effectively for the benefit of regulators (entities or organizations). Specifically, the limitations hinder the ability of AI to detect and address critical issues such as bootleg content, false news, misinformation, and malicious activities. The lack of robust continuous learning mechanisms prevents AI systems from adapting dynamically to evolving threats or identifying patterns that signify harmful actions. As a result, regulators face significant challenges in maintaining control, ensuring compliance, and protecting the public from the negative consequences of these activities.

Most existing AI platforms operate as closed systems, lacking transparency regarding the materials utilized for training, and no standardized repository exists for sharing and managing learning processes across systems. There is minimal or no visibility into the sources or origins of the data and information that contribute to AI training. Furthermore, this data lineage is neither evaluated nor recorded in audit logs, which compromises the traceability and accountability of AI systems.

Another significant limitation of current AI systems is their inability to explain their reasoning or the logic behind their decisions. This lack of explainability poses challenges for users, regulators, and stakeholders in trusting and verifying AI-driven outcomes. Additionally, the current systems are often inconsistent, failing to produce identical results even when the same process is repeated with identical inputs. This unreliability undermines confidence in AI applications, particularly in critical domains that demand reproducibility and consistency.

Moreover, existing systems lack a unified framework for managing distributed learning processes and their knowledge exchange. They fail to maintain trust relationships between processes or validate knowledge before sharing. Critically, no mechanism exists to integrate these functionalities with a continuous learning framework that adapts and improves over time based on new data, detected conflicts, and evolving domain-specific requirements.

Another significant problem with current AI services is their inability to differentiate between varying levels of trustworthiness in the information they exchange between learning processes. The systems process all information with the same implicit trust level, regardless of its source, accuracy, or relevance. There is no systematic review of the correctness or trustworthiness of the knowledge before sharing it between processes. Moreover, the systems lack mechanisms for filtering or prioritizing information based on reliability or domain-specific requirements, resulting in potential misinformation or misinterpretation of critical insights.

Furthermore, existing AI platforms predominantly rely on a cyclical process that involves collecting and releasing data in discrete batches, commonly referred to as the “train-build-release” model. This approach limits the systems to periodic updates and fixed cycles of learning, rather than enabling continuous learning. In “train-build-release” model, the AI is trained on a set batch of data, after which it undergoes a build phase to generate the model before being released for use. Once the release occurs, no further training or adaptation takes place until the next batch cycle begins. This limitation impedes not only continuous improvement but also the ability to effectively share and reuse learning processes across different domains and applications.

Given these challenges, there is a critical need for mechanisms that address the limitations of current AI systems, particularly in handling continuous learning, knowledge validation, and trust management.

### SUMMARY

According to one aspect of the disclosure, a machine learning system is provided. The system includes a processor and at least one non-transitory memory storing instructions. When executed, these instructions configure the system to obtain domain-specific Learning Processes (LPs) from an external repository, where each LP is associated with domain-specific knowledge graphs representing learned parameters, patterns, and processing capabilities.

The system receives operational data and generates pattern representations from this data. Based on matching these pattern representations with domain-specific knowledge graphs, the system identifies relevant LPs from the obtained set. The system then executes these LPs to generate results.

During execution, the system detects contradictions between execution results and existing domain knowledge, and validates results through contradiction resolution. The system updates both the LPs and their associated knowledge graphs based on validation outcomes, while also adapting trust relationships between LPs. Updated LPs and their knowledge graphs can be submitted back to the external repository.

In various embodiments, knowledge graphs serve dual purposes: as searchable indices for LP discovery and as interface definitions specifying LP capabilities. The system employs graph distance metrics to select relevant LPs and maintains version history during external repository updates.

In some embodiments, LPs maintain both inbound and outbound trust circles that adapt based on operational performance. These trust circles control knowledge acceptance and distribution between LPs, and can be modified based on validation outcomes, contradiction resolutions, or principal-directed modifications.

In further embodiments, the system processes operational data inputs at sub-millisecond intervals and maintains temporal ordering for regression testing. The system performs validation through regression testing against historical results and adjusts trust relationships based on contradiction resolutions.

According to another aspect of the disclosure, a method for implementing continuous machine learning is provided. The method includes obtaining domain-specific LPs from an external repository, processing operational data, and managing trust-based knowledge exchange between LPs.

These and other features and advantages of the present disclosure may be appreciated from a review of the following detailed description of the present disclosure, along with the accompanying figures in which like reference numerals refer to like parts throughout

### BRIEF DESCRIPTION OF THE FIGURES

FIG. 1 is a diagram that illustrates an exemplary environment within which various embodiments of the present invention may function.

FIG. 2 is a diagram that illustrates the system for continuous machine learning using one or more domain-specific learning processes, in accordance with various embodiments of the disclosure.

FIG. 3 is a diagram that illustrates a method for continuous machine learning using one or more domain-specific learning processes, in accordance with various embodiments of the disclosure.

### DESCRIPTION

Pursuant to various embodiments, the present disclosure provides a method and system that enables continuous machine learning. The system obtains a set of domain-specific learning processes (LPs) from an external repository maintaining a plurality of LPs. Each LP of the plurality of LPs is associated with at least one domain-specific knowledge graph representing learned parameters, patterns, and processing capabilities for that LP. The system receives an operational data and generates at least one pattern representation from the operational data. One or more relevant LPs from the set of domain-specific LPs are identified by matching the at least one pattern representation with the at least one domain-specific knowledge graph. The identified one or more relevant LPs are executed to generate execution results. The system detects contradictions between execution results and existing domain knowledge during the execution and validates the execution results through a contradiction resolution.

The one or more LPs and their associated domain-specific knowledge graphs, trust relationships between LPs are updated accordingly based on validation outcomes. The system submits the updated one or more LPs and their associated domain-specific knowledge graphs to the external repository.

In one or more embodiments, machine learning refers to a subset of AI that enables systems to automatically learn and improve from experience without being explicitly programmed. Machine learning involves the use of algorithms and statistical models to analyze and interpret complex data, identify patterns, make predictions, and refine processes over time. Unlike traditional rule-based systems, machine learning models evolve by learning from historical data and adjusting their parameters to enhance performance, accuracy, and efficiency. These systems can be supervised, unsupervised, or semi-supervised, depending on the availability and nature of the training data, and are applied across various domains such as natural language processing, computer vision, predictive analytics, and recommendation systems.

In one or more embodiments, ‘domain-specific’ refers to knowledge, processes, models, or learning techniques that are tailored to a particular field, industry, or area of expertise. A domain-specific system or component is designed to address the unique requirements, challenges, and nuances of a specific domain, such as healthcare, finance, manufacturing, or cybersecurity. It utilizes domain-relevant data, terminology, and insights to perform tasks and generate outcomes that are highly relevant and accurate for that particular domain. Domain-specific approaches enable more effective decision-making, problem-solving, and optimization by ensuring that the system is specifically aligned with the particular context or needs of the field in question. In the case of machine learning, domain-specific models or LPs focus on patterns, parameters, and knowledge that are directly applicable to the given domain, resulting in more targeted and meaningful outputs.

In one or more embodiments, an LP comprises a collection of machine learning models designed to operate within a specific domain. Each LP integrates multiple machine learning models that collectively analyze data, learn patterns, and make predictions or decisions within their domain context. These models may include supervised learning models, unsupervised learning models, semi-supervised learning models, reinforcement learning models, and deep learning models, working together to address domain-specific requirements. Each LP is designed to handle specialized data and tasks within its domain, utilizing various algorithms and statistical techniques to optimize performance. The LP maintains its domain knowledge through learned parameters, patterns, and processing capabilities, represented by associated knowledge graphs that enable knowledge exchange and evolution of the system.

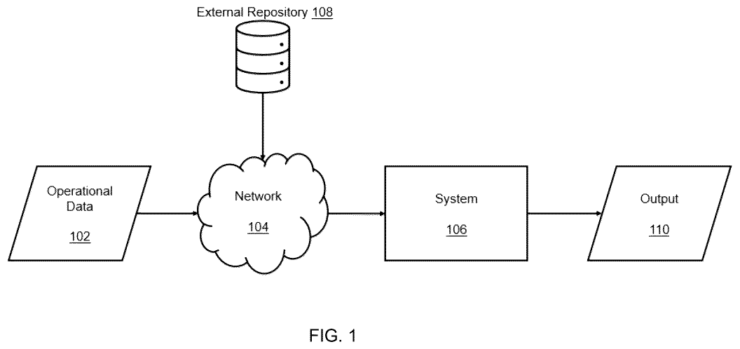

FIG. 1 is a diagram that illustrates an exemplary environment 100 within which various embodiments of the present disclosure may function. Referring to FIG. 1, the environment 100 includes operational data 102, a network 104, a system 106, an external repository 108, and output 110.

The operational data 102 refers to any type of data generated from multiple entities such as sensors, IoT devices, machines, systems, organizations, users, and other sources. The operational data 102 is typically generated continuously, reflecting real-time operations of activities, and is not confined to any specific time period or frequency. The operational data may span a wide range of time intervals, from seconds to hours, days, or even longer durations, depending on the nature of the data sources that are involved. The operational data 102 may originate from various locations, whether local or remote, across different geographical or network-based environments.

The network 104 includes communication networks operable to facilitate communication, either wirelessly or wired. The network 104 connects a plurality of computer systems. The network 104 may comprise, for example, an intranet, local area network, wide area network, the internet, public switched telephone network (PSTN), network of networks, or other network.

The system 106 is initialized by obtaining a set of domain-specific LPs from the external repository 108 based on system objectives and domain requirements, where each LP is associated with at least one domain-specific knowledge graph. Upon receiving operational data 102 from various sources, the system generates pattern representations from this operational data and identifies one or more LPs from the set of domain-specific LPs by matching these pattern representations with the domain-specific knowledge graphs corresponding to the one or more LPs. The system 106 then executes the identified LPs to generate execution results which are validated through contradiction resolution. Based on validation outcomes, the system 106 updates the LPs and their associated domain-specific knowledge graphs, along with trust relationships between LPs, and enables submission of these updated LPs and their associated knowledge graphs to the external repository 108.

In some non-limiting embodiments, the system 106 is configured to receive the plurality of LPs from the external repository 108 using Application Programming Interfaces (APIs). These APIs facilitate the seamless exchange of data and models between the system 106 and the external repository 108, enabling the system 106 to retrieve the necessary LPs on demand. By leveraging APIs, the system 106 can access a wide variety of domain-specific LPs stored in the external repository 108, ensuring that it has the most up-to-date and relevant LPs to address the specific needs of the operational environment.

The external repository 108 refers to a centralized storage system or database that maintains a collection of LPs, domain-specific knowledge graphs, models, and other related resources. The external repository 108 serves as a source for storing and managing a wide array of domain-specific LPs that can be accessed by the system 106 as needed. The external repository 108 is typically designed to be accessible via APIs, facilitating smooth integration and data exchange between the external repository 108 and the system 106. It may be located remotely or in the cloud, allowing for scalability and flexibility in managing large volumes of domain-specific data and models across various environments and use cases.

In one or more embodiments, the external repository 108 is configured to maintain one or more of, but not limited to, template graph patterns for LPs discovery, operational performance metrics for each LP, and historical trust relationships between LPs.

In one or more embodiments, template graph patterns for LP discovery represent predefined structures or frameworks that help in identifying and categorizing LPs based on their inherent patterns and characteristics.

In one or more embodiments, operational performance metrics for each LP track and record the performance of each LP over time. The metrics may include accuracy, speed, resource consumption, and other relevant measures that assess the effectiveness and suitability of each LP.

In one or more embodiments, the historical trust relationships between LPs capture and document the history of interactions and dependencies among different LPs, which help assess the reliability and consistency of LPs.

The output 110 refers to results generated by execution of the identified relevant LPs. The results represent the outcomes of applying the selected LPs to the operational data 102, reflecting the insights, predictions, or decisions derived from the machine learning models. The output 110 can take various forms depending on the type of LPs executed, such as numerical predictions, classification labels, anomaly detection flags, recommendations, or other domain-specific results. The output 110 is critical for informing further actions, validating results, and updating models or knowledge graphs, contributing to the system's 106 continuous learning cycle.

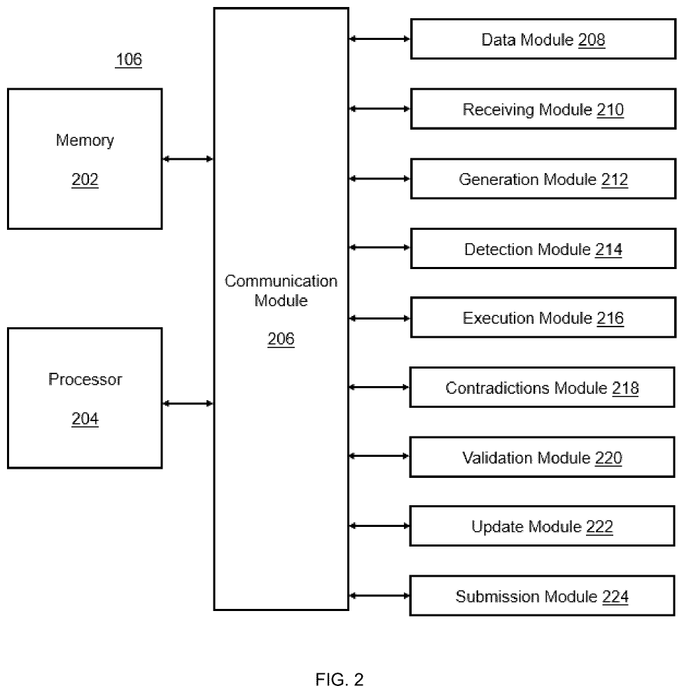

FIG. 2 is a diagram that illustrates the system 106 for continuous machine learning using one or more domain-specific LPs, in accordance with various embodiments of the disclosure. Referring to FIG. 2, the system 106 includes a memory 202, a processor 204, a communication module 206, a data module 208, a receiving module 210, a generation module 212, a detection module 214, an execution module 216, a contradictions module 218, a validation module 220, an update module 222, and a submission module 224.

The memory 202 may comprise suitable logic, and/or interfaces, that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the system 106 in accordance with various aspects of the present disclosure. The processor 204 may be further configured to communicate with various modules of the system 106 via the communication module 206.

The data module 208 may comprise suitable logic, code, and/or interfaces that may be configured to obtain, during system initialization, a set of domain-specific LPs from the external repository 108 based on system objectives and domain requirements. The data module 208 is responsible for establishing communication with the external repository 108 and facilitating the initial retrieval of LPs that align with the system's intended functionality. The logic within the data module 208 enables selection of appropriate LPs based on their domain-specific capabilities and the system's operational requirements.

In one or more embodiments, each LP of the external repository 108 is associated with one or more domain-specific knowledge graphs. A domain-specific knowledge graph associated with a LP represents learned parameters, patterns, and processing capabilities for that LP.

In one or more embodiments, the learned parameters refer to key variables or factors that the LP has learned during its training phase. For instance, the parameters may include weights, biases, thresholds, or other relevant values that define how the LP processes input data and generates output.

In one or more embodiments, the knowledge graph captures the patterns or relationships the LP has identified from the data it has been trained on. For instance, the patterns may include correlations, trends, classifications, or any other insights that the LP uses to interpret data and make predictions or decisions.

In one or more embodiments, the knowledge graph also represents the processing capabilities of the LP, such as the algorithms or methodologies the LP employs to process data. For instance, this may include the types of machine learning techniques used (e.g., supervised learning, unsupervised learning, reinforcement learning) and the specific ways the LP handles and processes data in its domain.

In one or more embodiments, each domain-specific knowledge graph in the external repository 108 serves as a searchable index for LP discovery and an interface definition specifying LP capabilities. Each domain-specific knowledge graph acts as an organized structure that allows the system 106 to efficiently search for and discover relevant LPs. By storing key parameters, patterns, and capabilities of each LP, the domain-specific knowledge graph facilitates quick identification and retrieval of LPs that match the requirements of the operational data or task at hand.

In one or more embodiments, the knowledge graph also defines the capabilities of each LP through a structured interface, which outlines the functional attributes, input-output requirements, processing methods, and the specific tasks the LP is designed to handle.

The receiving module 210 may comprise suitable logic, code, and/or interfaces that may be configured to receive operational data. The receiving module 210 is responsible for collecting, processing, and transmitting the operational data to other components of the system 106. The logic within the receiving module 210 organizes and processes the data to meet the necessary criteria for further analysis. The code and interfaces facilitate seamless interaction between the receiving module 210 and various data sources, allowing for real-time or batch data collection from different entities, such as sensors, machines, users, or external systems.

The generation module 212 may comprise suitable logic, code, and/or interfaces that may be configured to transform received operational data into structured pattern representations. Through advanced data processing techniques, the generation module 2112 analyzes the operational data to systematically identify, extract, and abstract meaningful patterns, statistical trends, and underlying relational structures. The resulting pattern representation provides a condensed, semantically rich data model that encapsulates critical information characteristics, enabling efficient mapping and alignment with one or more LPs and their associated knowledge graphs.

The detection module 214 may comprise suitable logic, code, and/or interfaces that may be configured to identify one or more relevant LPs from the set of domain-specific LPs. Instead of a direct one-to-one match, the detection module 214 is configured to evaluate multiple pattern representations simultaneously and rank them based on their alignment with various domain-specific knowledge graphs. The detection module 214 can then select the LPs that may exhibit the highest degree of relevance or fit to the operational data.

In one or more embodiments, identifying the one or more relevant LPs by the detection module 214 involves generating a graph distance metric between the determined processing requirements and the domain-specific knowledge graphs.

In an exemplary embodiment, the graph distance metric refers to a quantitative measure that calculates the similarity or dissimilarity between the determined processing requirements (derived from the operational data 102) and the structure, parameters, and patterns represented in the domain-specific knowledge graphs. For instance, the metric may be based on various mathematical methods, such as graph theory techniques (e.g., shortest path, similarity scoring, or node degree comparisons), that evaluate how closely the operational data's 102 features align with the attributes and relationships encoded in the knowledge graph.

In one or more embodiments, the detection module 214 then selects the one or more relevant LPs based on the generated distance metric. The LPs with the shortest or most favorable distance metrics are considered the most relevant, as they are likely to be the best fit for processing the operational data.

The execution module 216 may comprise suitable logic, code, and/or interfaces that may be configured to execute the identified one or more relevant LPs. Upon receiving the one or more relevant LPs from the detection module 214, the execution module 216 carries out the necessary computations, or inference tasks as defined by the LPs.

In some non-limiting embodiments, the execution results may include predictions, classifications, or other types of outputs depending on the nature of the LPs and the operational data 102 being processed. The results may encompass predictions, such as forecasting future trends or behaviors based on historical data, classifications, where the system 106 categorizes data into predefined groups or labels, or other types of results, such as regressions, anomaly detection outcomes, or decision-making suggestions.

In one or more embodiments, each LP is configured to transfer inputs and the generated results among the identified one or more relevant LPs by utilizing the corresponding domain-specific knowledge graphs. The transfer is facilitated by the knowledge graphs, which act as a communication layer that defines the relationships, dependencies, and data flow between different LPs. By using the knowledge graphs, the system 106 can ensure that the outputs of an LP are appropriately passed as inputs to other LPs, enabling an integration of processes and a cohesive learning workflow.

In an exemplary embodiment, transferring inputs and generated results between the LPs using domain-specific knowledge graphs may occur as follows:

Consider a system designed to analyze customer purchasing behavior in an e-commerce platform. The first LP might be a recommendation system, responsible for predicting which products a customer is likely to purchase based on historical data. The inputs to this LP could include customer preferences, browsing history, and product features, while the output would be a ranked list of product recommendations.

Once the recommendation system generates its results, the system passes this output as an input to the second LP, which could be a demand forecasting model, which predicts future product demand based on current trends and seasonal factors. The domain-specific knowledge graph governing the interaction between the two LPs enables recommendation output from the first LP to be correctly interpreted and transformed into a relevant input for the demand forecasting model.

In accordance with the exemplary embodiment, the demand forecasting model then produces an output, such as predicted sales volumes for the recommended products. The result is subsequently transferred to a third LP, which could be an inventory optimization model, which uses the sales forecast to optimize stock levels, ensuring that the right amount of inventory is available for the predicted demand.

In one or more embodiments, each LP among the identified one or more relevant LPs, maintains and adapts inbound trust circles for knowledge acceptance and outbound trust circles for knowledge distribution. The inbound trust circles represent a set of trusted sources from which the LP accepts inputs or knowledge updates, ensuring that the incoming data or knowledge aligns with the LP's operational standards. The outbound trust circles define the entities or processes to which the LP distributes its learned knowledge or execution results, based on criteria such as accuracy, reliability, and relevance of the knowledge generated.

In some non-limiting embodiments, the trust circles are dynamically adapted based on the LP's operational performance, such as, for example, its success in producing accurate results, resolving contradictions, or enhancing downstream processes.

In one or more embodiments, the trust circles are dynamically modified based on one or more of operational validation outcomes, contradiction resolution results, and principal-directed modifications.

Operational validation outcomes involve assessing the performance and reliability of knowledge or data processed by an LP, allowing trust relationships to be strengthened or weakened accordingly. Contradiction resolution results provide insights into the consistency of execution results with existing domain knowledge, enabling adjustments to trust circles based on the resolution of detected discrepancies. Principal-directed modifications allow authorized stakeholders to manually adjust trust relationships, ensuring alignment with domain-specific goals or compliance requirements.

In one or more embodiments, trust circles are configured to control the acceptance of knowledge from other LPs and the distribution of knowledge to other LPs. The acceptance of knowledge is governed by the inbound trust circle, which determines whether incoming knowledge from other LPs meets predefined trustworthiness criteria such as source reliability, validation accuracy, or alignment with the domain-specific knowledge graph. Similarly, the distribution of knowledge is managed by the outbound trust circle, which specifies the LPs that are eligible to receive the generated results or learned knowledge, based on factors such as the operational performance of the recipient LPs or predefined trust parameters.

The contradictions module 218 may comprise suitable logic, code, and/or interfaces that may be configured to detect contradictions between the generated execution results and existing domain knowledge. In the context, the contradictions module 218 examines the execution results produced by the one or more relevant LPs and compares them against the established knowledge base or domain-specific rules that have been previously encoded or learned. For instance, if the execution results diverge significantly from the domain knowledge such as when a result contradicts known patterns, expectations, or established facts, the contradictions module 218 identifies these discrepancies.

In some non-limiting embodiments, the knowledge base refers to a structured repository of domain-specific information, patterns, learned parameters, and operational rules that are associated with the LPs. The knowledge base may include, but is not limited to, domain-specific knowledge graphs, historical performance metrics, validation records, trust relationships, and templates for graph patterns. The knowledge base serves as a centralized reference to store and retrieve information, enabling LPs to enhance their learning, detect contradictions, and adapt their operations based on updated insights.

Consider an exemplary embodiment, where the system 106 uses a fraud detection model (LP) that analyzes transaction patterns to identify fraudulent activity. The LP is trained on historical transaction data and established patterns of fraudulent behavior. It flags a particular transaction as potentially fraudulent because it deviates from the typical spending patterns observed for the customer. The generated execution result from the LP is a flag indicating that the transaction is fraudulent based on its location and amount, which deviate from previous transactions made by the customer.

However, upon reviewing the domain knowledge, which may include customer-specific preferences, previous transactions, or a broader knowledge base of legitimate behaviors, the contradictions module 218 detects that the flagged transaction aligns with the customer's historical spending during a holiday season or a special promotion, which was not accounted for in the initial model. The contradiction, in this case, is that while the LP (fraud detection model) classified the transaction as fraudulent, the existing domain knowledge (i.e., the customer's historical patterns during holidays) indicates that such transactions are legitimate. The contradictions module 218 is configured to detect the inconsistency and flag it for further validation or review.

The validation module 220 may comprise suitable logic, code, and/or interfaces configured to validate the execution results through a contradiction resolution, which involves comparing the execution results against historical execution outcomes stored in the knowledge base to identify deviations. Regression testing is performed by the validation module 220 to verify if the new execution results remain consistent with previously validated outcomes, maintaining the reliability of the outputs.

In one or more embodiments, validating the execution results further includes detecting contradictions by assessing alignment or disparities with existing domain-specific knowledge graphs. When contradictions are identified, the validation module 220 resolves them and adjusts trust relationships within the knowledge base.

In one or more embodiments, the LPs evolve independently by adapting their internal models based on the validated results of prior executions. The adaptation process involves refining the underlying algorithms, adjusting parameters, or modifying the approach based on the outcomes of the validation and contradiction resolution steps. For example, if an LP detects a pattern in the data that was previously unrecognized, it may adjust its model to incorporate this new pattern, improving future predictions or classifications.

Additionally, the LPs modify their knowledge exchange patterns based on operational accuracy, indicating that as the LPs process more data and gather more experience, they refine the way they communicate and share knowledge with other LPs or external systems. For instance, an LP might adjust the frequency, scope, or type of information it shares with other LPs, optimizing how knowledge is disseminated to support better decision-making. If an LP's operational accuracy improves or declines, its knowledge exchange protocol may be altered to better reflect its current state, ensuring that only the most relevant and reliable information is passed on, and reducing the risk of propagating errors through the system.

The update module 222 may comprise suitable logic, code, and/or interfaces that may be configured to update the one or more LPs and their associated domain-specific knowledge graphs, and trust relationships between the one or more LPs based on the validation outcomes, which may include adjustments to parameters, incorporation of new knowledge patterns, or reconfiguration of processing capabilities.

In one or more embodiments, updating the one or more LPs by the update module 222 involves removing invalidated knowledge that no longer aligns with validated outcomes, ensuring that only reliable and accurate data remains within the LPs. Additionally, the update module 222 adjusts learning parameters based on the validation outcomes, fine-tuning the LPs to improve their performance and adapt to newly acquired insights. The update module 222 may also modify knowledge exchange protocols to optimize how LPs communicate and share information, to enable flow of data between LPs reflecting the most up-to-date and trusted knowledge, as well as addressing any identified contradictions or inconsistencies.

The submission module 224 may comprise suitable logic, code, and/or interfaces that may be configured to enable submission of the updated one or more LPs and their associated domain-specific knowledge graphs to the external repository 108.

In one or more embodiments, submission of the updated one or more LPs by the submission module 224 involves several steps to reflect the most recent changes in the external repository 108, which includes updating the searchable indices and knowledge graphs to incorporate the newly updated LPs, enabling efficient and accurate discovery of relevant LPs.

In one or more embodiments, the submission module 224 also modifies interface definitions and processing capabilities to align with the changes in the LPs, maintaining compatibility with other systems and the integrity of interactions between LPs. Additionally, the submission module 224 maintains a version history of the LPs, recording all modifications made over time, which provides an audit trail and facilitates tracking of the evolution of the LPs, with the option for rollback if necessary.

In an exemplary embodiment, the version history maintained by the submission module 224 tracks all modifications made to the LPs over time. Each update to an LP generates a new version entry in the version history, which includes details such as the date and time of the modification, the specific changes made to the LP or its associated knowledge graph, and the reasons for the update. For instance, if a new learning parameter is added or an existing one is adjusted based on validation outcomes, the change is recorded with a version number.

In some non-limiting embodiments, the system 106 is configured to handle high-frequency operational data inputs, with the capability to process inputs that are received less than one millisecond apart. This system 106 is configured to manage and process a continuous flow of data with extremely low latency, making it suitable for real-time applications that require quick, dynamic responses. For example, in environments where sensors or IoT devices are continuously generating data at rapid intervals, the system 106 is capable of processing each input promptly without lag or delay, ensuring the timely execution of LPs.

In some non-limiting embodiments, the system 106 is further optimized to execute the identified relevant LPs within one millisecond of receiving the operational data. This low-latency execution ensures that the system 106 reacts to data inputs almost instantaneously, making it highly responsive in time-sensitive scenarios.

In some non-limiting embodiments, the system 106 also maintains the temporal order of the processed operational data for the purpose of regression testing, which plays a key role for validating the accuracy and consistency of the system's 106 outputs over time. By preserving the sequence of data as it was originally received, the system 106 can ensure that any changes in execution results are due to the new input data and not a reordering or misinterpretation of prior data.

### Exemplary Use Case 1

Autonomous and Intelligent Industrial Forklift System

### Scenario Overview

An industrial developer team is tasked with designing and deploying an intelligent, autonomous forklift for factory environments. The forklift must adhere to stringent operational and safety constraints while minimizing costs and energy consumption. The system needs to observe its environment through multiple sensory modalities, respond to spoken commands, and autonomously carry out its tasks while ensuring the safety of humans and property within the factory.

The forklift must:
1. Observe its surroundings using visual sensors (cameras), audio sensors, radar, thermal imaging, and pressure sensors.
2. Respond to spoken instructions from workers via a human voice interface.
3. Perform load-carrying tasks for weights ranging from 10 kg to 1,000 kg over distances up to 10,000 meters, with operational heights of 2 cm to 1,000 cm.
4. Avoid harming humans, damaging structures, or colliding with other objects within the factory floor.
5. Operate exclusively indoors without the need to navigate open or external spaces.
6. Be cost-effective in terms of both purchase and operational expenses.

### Component Identification:

The development team identifies critical subsystems to achieve the required functionality:
Visual System (“Vision”): Comprising accurate cameras and AI-powered image processing for environment awareness and object recognition.
Audio System (“Audio”): Integrating microphones and AI sound processing for interpreting verbal commands.
Radar and Thermal Systems (“Radar” and “Thermal”): Enabling enhanced environmental mapping and obstacle detection.
Pressure Sensors (“Pressure”): Providing tactile feedback for safe load handling.
Human Voice Interface (“HCI”): Allowing interaction with workers through voice commands and clarification dialogues.
Movement System (“Move”): Responsible for route planning, collision avoidance, and error correction.
Load Carrying System (“Load”): Integrated with vision and pressure sensors to securely handle loads, augmented with RFID or similar technology for load identification.

### Leveraging the AI Component Repository:

The team accesses an external repository to search for modular Learning Processes (LPs) suited to each functional requirement. Using search phrases like “collision avoidance LP” or “speech recognition LP,” the repository transforms these queries into knowledge graphs and retrieves a curated set of LPs optimized for the required tasks.

### System Integration:

The team builds a lightweight Continuous Machine Learning System (CMLS) to govern the forklift's operation. The system integrates the identified LPs (e.g., “Vision,” “Audio,” “Move”) into a modular framework. Content classification engines connect these components, translating sensor inputs into actionable knowledge graphs, which are then processed by the corresponding LPs.

### System Deployment and Learning

Once the forklift system is operational:
Activation: All LPs initialize in their baseline state, prepared to process inputs and execute tasks.
Adaptive Learning: The system continuously learns from its environment, adapting to task-specific requirements, worker communication patterns, and factory floor layouts. For example:
   The “Vision” module learns the positions of static and dynamic obstacles.
   The “Audio” module adapts to varying accents or speech patterns of workers.
   The “Move” module refines path-planning algorithms based on historical performance and factory layout changes.

Continuous Learning and Trust Evolution: The system demonstrates continuous learning through:
Validation of LP Results: When the forklift executes tasks, each LP's output is validated against actual outcomes. For example:
   The “Vision” LP's object detection results are validated against successful/unsuccessful interactions.
   The “Move” LP's path planning is validated against actual navigation efficiency
   The “Audio” LP's command interpretation is validated against worker confirmations.
Contradiction Resolution: The system detects and resolves contradictions between LPs. For instance:
   When “Vision” LP detects a clear path but “Radar” LP indicates an obstacle
   When “Audio” LP interprets a command that conflicts with “Load” LP's weight limitations
   When “Move” LP's planned path contradicts “Thermal” LP's safety warnings
Trust Relationship Evolution: Based on validation outcomes:
   LPs with consistently accurate results gain higher trust levels
   Knowledge sharing between LPs is prioritized based on trust levels
   Critical safety-related LPs maintain strict trust thresholds
Repository Updates: The system contributes improved LPs back to the repository:
   “Vision” LP enhanced with factory-specific object recognition
   “Move” LP optimized for specific layout patterns
   “Audio” LP adapted to local language variations

### Benefits of Modularity

The modular design drastically reduces system complexity compared to a monolithic AI model. For instance:
Each component addresses a specific sub-problem, enabling targeted learning and optimization.
The reduced model size significantly lowers computational resource requirements. Instead of requiring 10-20 racks of high-end servers for a monolithic model, the modular system operates efficiently on individual high-end machines for each LP, achieving savings of two to three orders of magnitude in cost and energy.

### Exemplary Use Case 2

Building and Operating a Continuous Machine Learning System (CMLS) for Sports Betting Advice using circles of trust.

### Scenario Overview

This use case demonstrates a continuous learning system deployed for sports betting advice, focusing on how Learning Processes (LPs) evolve through operational validation and trust-based knowledge exchange. The system initializes with specific domain LPs obtained from an external repository, where each LP specializes in particular sports or betting patterns and is associated with a knowledge graph representing its capabilities.

### System Requirements and Initialization:

The developer team first identifies domain requirements and necessary LP capabilities for sports betting analysis. Based on these requirements, the system is initialized by obtaining domain-specific LPs from the external repository. Each obtained LP is associated with a knowledge graph that represents its learned parameters, patterns, and processing capabilities in sports analysis.

### System Operation:

Upon receiving sports data, the system identifies relevant LPs from its initialized set by matching data patterns with LP knowledge graphs. The identified LPs process the data to generate betting predictions. During execution, the system detects any contradictions between different LPs' predictions and validates results against actual sports outcomes.

### Continuous Learning Implementation:

The system's continuous learning operates through:
Validation of LP predictions against actual sports outcomes
Detection and resolution of contradictions between different LPs predictions
Evolution of trust relationships based on prediction accuracy
Updates to LP knowledge based on validated results

### Trust Evolution:

Trust relationships between LPs evolve based on operational performance. LPs that consistently provide accurate predictions gain higher trust levels, influencing their knowledge sharing permissions. The system adjusts these trust relationships based on:
Accuracy of betting predictions
Successful resolution of contradictions
Validation against actual outcomes

### Repository Updates:

When validation confirms improvements in LP performance, the system:
Updates the LP's internal model based on validated learning
Enhances the associated knowledge graph to reflect new capabilities
Enables submission of improved LPs back to the repository
Maintains continuous operation during updates

### System Benefits:

This implementation demonstrates key advantages of the continuous learning architecture:
Ongoing improvement through operational validation
Trust-based knowledge evolution
Non-disruptive updates to repository
Domain-specific learning through specialized LPs

### Benefits of Circle of Trust

The Circle of Trust mechanism ensures efficient data handling and improved system reliability:
Faster Processing: By filtering low-confidence hints early, the system reduces computational overhead and focuses on high-quality data.
Economical Modularity: Breaking the system into specialized LPs minimizes the size and complexity of each module, reducing resource consumption.
Scalable Improvement: The trust circles enable each LP to improve independently, driving the overall accuracy and efficiency of the system.

For instance, a monolithic AI model handling all sports betting tasks would require extensive computational resources, such as multiple high-end servers. In contrast, the modular approach supported by trust circles reduces this requirement to one high-performance computer per LP, saving costs by several orders of magnitude.

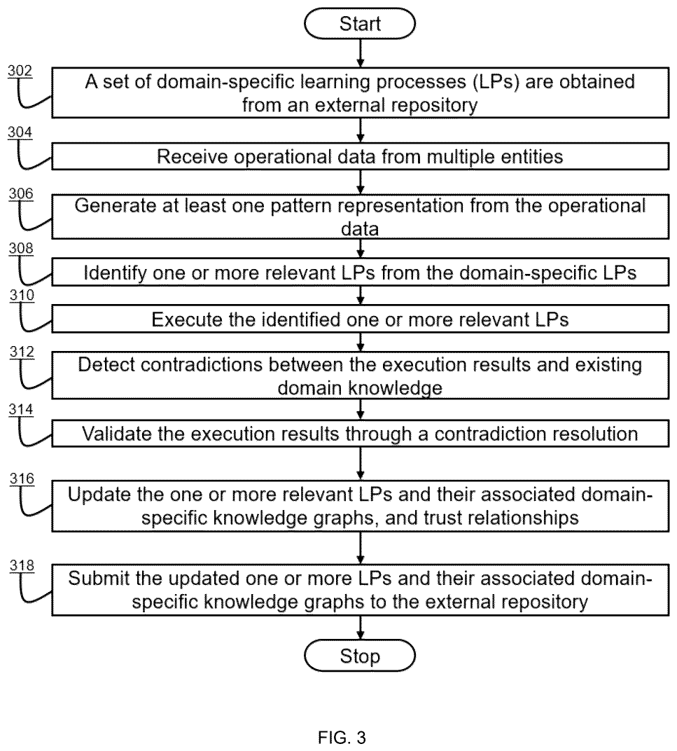

FIG. 3 is a diagram that illustrates a flow chart 300 for a method for continuous machine learning using one or more domain-specific LPs, in accordance with various embodiments of the disclosure.

At 302, during system initialization, the data module 208 obtains a set of domain-specific LPs from the external repository 108 based on system objectives and domain requirements. The data module 208 establishes communication with the external repository 108 and facilitates the retrieval of appropriate LPs aligned with the system's intended functionality.

In one or more embodiments, each LP of the external repository 108 is associated with at least one domain-specific knowledge graph. The domain-specific knowledge graph associated with the LP represents learned parameters, patterns, and processing capabilities for that LP.

In one or more embodiments, the learned parameters refer to key variables or factors that the LP has learned during its training phase. For instance, the parameters may include weights, biases, thresholds, or other relevant values that define how the LP processes input data and generates output.

In one or more embodiments, the knowledge graph captures the patterns or relationships the LP has identified from the data it has been trained on. For instance, the patterns may include correlations, trends, classifications, or any other insights that the LP uses to interpret data and make predictions or decisions.

At 304, the receiving module 210 receives operational data from multiple entities such as sensors, IoT devices, machines, systems, organizations, users, and other sources. The receiving module 210 is responsible for collecting, processing, and transmitting the operational data to other components of the system 106. The logic within the receiving module 210 organizes and processes the data to meet the necessary criteria for further analysis. The code and interfaces facilitate seamless interaction between the receiving module 210 and various data sources, allowing for real-time or batch data collection from different entities, such as sensors, machines, users, or external systems.

At 306, the generation module 212 generates at least one pattern representation from the received operational data. The generation module 212 processes the operational data to identify and extract meaningful patterns, trends, or relationships that are relevant for the LP. The generated pattern representation serves as a structured form of the data, capturing key features or insights that can be used to match with the appropriate LPs or knowledge graphs.

At 308, the detection module 214 identifies one or more relevant LPs from the set of domain-specific LPs. Instead of a direct one-to-one match, the detection module 214 is configured to evaluate multiple pattern representations simultaneously and rank them based on their alignment with various domain-specific knowledge graphs. The detection module 214 can then select the LPs that may exhibit the highest degree of relevance or fit to the operational data.

In one or more embodiments, identifying the one or more relevant LPs by the detection module 214 involves generating a graph distance metric between the determined processing requirements and the domain-specific knowledge graphs.

In an exemplary embodiment, the graph distance metric refers to a quantitative measure that calculates the similarity or dissimilarity between the determined processing requirements (derived from the operational data 102) and the structure, parameters, and patterns represented in the domain-specific knowledge graphs. For instance, the metric may be based on various mathematical methods, such as graph theory techniques (e.g., shortest path, similarity scoring, or node degree comparisons), that evaluate how closely the operational data's 102 features align with the attributes and relationships encoded in the knowledge graph.

In one or more embodiments, the detection module 214 then selects the one or more relevant LPs based on the generated distance metric. The LPs with the shortest or most favorable distance metrics are considered the most relevant, as they are likely to be the best fit for processing the operational data.

At 310, the execution module 216 executes the identified one or more relevant LPs. Upon receiving the relevant LPs from the detection module 214, the execution module 216 carries out the necessary computations, or inference tasks as defined by the LPs.

In some non-limiting embodiments, the execution results may include predictions, classifications, or other types of outputs depending on the nature of the LPs and the operational data 102 being processed. The results may encompass predictions, such as forecasting future trends or behaviors based on historical data, classifications, where the system 106 categorizes data into predefined groups or labels, or other types of results, such as regressions, anomaly detection outcomes, or decision-making suggestions.

In one or more embodiments, each LP is configured to transfer inputs and the generated results among the identified one or more relevant LPs by utilizing the corresponding domain-specific knowledge graphs. The transfer is facilitated by the knowledge graphs, which act as a communication layer that defines the relationships, dependencies, and data flow between different LPs. By using the knowledge graphs, the system 106 can ensure that the outputs of one LP are appropriately passed as inputs to other LPs, enabling an integration of processes and a cohesive learning workflow.

In one or more embodiments, each LP among the identified one or more relevant LPs, maintains and adapts inbound trust circles for knowledge acceptance and outbound trust circles for knowledge distribution. The inbound trust circles represent a set of trusted sources from which the LP accepts inputs or knowledge updates, ensuring that the incoming data or knowledge aligns with the LP's operational standards. The outbound trust circles define the entities or processes to which the LP distributes its learned knowledge or execution results, based on criteria such as accuracy, reliability, and relevance of the knowledge generated.

In some non-limiting embodiments, the trust circles are dynamically adapted based on the LP's operational performance, such as, for example, its success in producing accurate results, resolving contradictions, or enhancing downstream processes.

In one or more embodiments, the trust circles are dynamically modified based on at least one of operational validation outcomes, contradiction resolution results, and principal-directed modifications. Operational validation outcomes involve assessing the performance and reliability of knowledge or data processed by an LP, allowing trust relationships to be strengthened or weakened accordingly. Contradiction resolution results provide insights into the consistency of execution results with existing domain knowledge, enabling adjustments to trust circles based on the resolution of detected discrepancies. Principal-directed modifications allow authorized stakeholders to manually adjust trust relationships, ensuring alignment with domain-specific goals or compliance requirements.

In one or more embodiments, trust circles are configured to control the acceptance of knowledge from other LPs and the distribution of knowledge to other LPs. The acceptance of knowledge is governed by the inbound trust circle, which determines whether incoming knowledge from other LPs meets predefined trustworthiness criteria such as source reliability, validation accuracy, or alignment with the domain-specific knowledge graph. Similarly, the distribution of knowledge is managed by the outbound trust circle, which specifies the LPs that are eligible to receive the generated results or learned knowledge, based on factors such as the operational performance of the recipient LPs or predefined trust parameters.

At 312, the contradictions module 218 detects contradictions between the generated execution results and existing domain knowledge. In the context, the contradictions module 218 examines the execution results produced by the one or more relevant LPs and compares them against the established knowledge base or domain-specific rules that have been previously encoded or learned. For instance, if the execution results diverge significantly from the domain knowledge such as when a result contradicts known patterns, expectations, or established facts, the contradictions module 218 identifies these discrepancies.

In some non-limiting embodiments, the knowledge base refers to a structured repository of domain-specific information, patterns, learned parameters, and operational rules that are associated with the LPs. The knowledge base may include, but is not limited to, domain-specific knowledge graphs, historical performance metrics, validation records, trust relationships, and templates for graph patterns. The knowledge base serves as a centralized reference to store and retrieve information, enabling LPs to enhance their learning, detect contradictions, and adapt their operations based on updated insights.

At 314, the validation module 220 validates the execution results through a contradiction resolution, which involves comparing the execution results against historical execution outcomes stored in the knowledge base to identify deviations. Regression testing is performed by the validation module 220 to verify if the new execution results remain consistent with previously validated outcomes, maintaining the reliability of the outputs.

In one or more embodiments, validating the execution results further includes detecting contradictions by assessing alignment or disparities with existing domain-specific knowledge graphs. When contradictions are identified, the validation module 220 resolves them and adjusts trust relationships within the knowledge base.

In one or more embodiments, the LPs evolve independently by adapting their internal models based on the validated results of prior executions. The adaptation process involves refining the underlying algorithms, adjusting parameters, or modifying the approach based on the outcomes of the validation and contradiction resolution steps. For example, if an LP detects a pattern in the data that was previously unrecognized, it may adjust its model to incorporate this new pattern, improving future predictions or classifications.

Additionally, the LPs modify their knowledge exchange patterns based on operational accuracy, indicating that as the LPs process more data and gather more experience, they refine the way they communicate and share knowledge with other LPs or external systems. For instance, an LP might adjust the frequency, scope, or type of information it shares with other LPs, optimizing how knowledge is disseminated to support better decision-making. If an LP's operational accuracy improves or declines, its knowledge exchange protocol may be altered to better reflect its current state, ensuring that only the most relevant and reliable information is passed on, and reducing the risk of propagating errors through the system.

At 316, the update module 222 updates the one or more relevant LPs and their associated domain-specific knowledge graphs, and trust relationships between the one or more LPs based on the validation outcomes, which may include adjustments to parameters, incorporation of new knowledge patterns, or reconfiguration of processing capabilities.

In one or more embodiments, updating the one or more LPs by the update module 222 involves removing invalidated knowledge that no longer aligns with validated outcomes, ensuring that only reliable and accurate data remains within the LPs. Additionally, the update module 222 adjusts learning parameters based on the validation outcomes, fine-tuning the LPs to improve their performance and adapt to newly acquired insights. The update module 222 may also modify knowledge exchange protocols to optimize how LPs communicate and share information, to enable flow of data between LPs reflecting the most up-to-date and trusted knowledge, as well as addressing any identified contradictions or inconsistencies.

At 318, the submission module 224 submits one or more updated LPs and their associated domain-specific knowledge graphs to the external repository 108.

In one or more embodiments, submission of the updated one or more LPs by the submission module 224 involves several steps to reflect the most recent changes in the external repository 108, which includes updating the searchable indices and knowledge graphs to incorporate the newly updated LPs, enabling efficient and accurate discovery of relevant LPs.

In one or more embodiments, the submission module 224 also modifies interface definitions and processing capabilities to align with the changes in the LPs, maintaining compatibility with other systems and the integrity of interactions between LPs. Additionally, the submission module 224 maintains a version history of the LPs, recording all modifications made over time, which provides an audit trail and facilitates tracking of the evolution of the LPs, with the option for rollback if necessary.

In an exemplary embodiment, the version history maintained by the submission module 224 tracks all modifications made to the LPs over time. Each update to an LP generates a new version entry in the version history, which includes details such as the date and time of the modification, the specific changes made to the LP or its associated knowledge graph, and the reasons for the update. For instance, if a new learning parameter is added or an existing one is adjusted based on validation outcomes, the change is recorded with a version number.

In some non-limiting embodiments, the system 106 is configured to handle high-frequency operational data inputs, with the capability to process inputs that are received less than one millisecond apart. This system 106 is configured to manage and process a continuous flow of data with extremely low latency, making it suitable for real-time applications that require quick, dynamic responses. For example, in environments where sensors or IoT devices are continuously generating data at rapid intervals, the system 106 is capable of processing each input promptly without lag or delay, ensuring the timely execution of LPs.

In some non-limiting embodiments, the system 106 is further optimized to execute the identified relevant LPs within one millisecond of receiving the operational data. This low-latency execution ensures that the system 106 reacts to data inputs almost instantaneously, making it highly responsive in time-sensitive scenarios.

In some non-limiting embodiments, the system 106 also maintains the temporal order of the processed operational data for the purpose of regression testing, which plays a key role for validating the accuracy and consistency of the system's 106 outputs over time. By preserving the sequence of data as it was originally received, the system 106 can ensure that any changes in execution results are due to the new input data and not a reordering or misinterpretation of prior data.

The method and system is advantageous as it enables domain-specific initialization of LPs through an external repository, allowing systems to be configured with precisely targeted capabilities for their intended functionality. This structured approach to system initialization ensures optimal configuration for specific operational requirements.

Furthermore, the method and system is advantageous as it implements knowledge graphs for efficient process identification and knowledge representation. The knowledge graphs enable rapid matching of operational requirements with process capabilities, while also providing a structured framework for representing and sharing domain knowledge.

Moreover, the method and system is advantageous as it incorporates automatic contradiction detection and validation mechanisms during execution. This capability ensures the integrity of learning outcomes and enables systematic knowledge evolution through validated results.

Additionally, the method and system is advantageous as it implements trust-based knowledge exchange between LPs. This structured approach to knowledge sharing ensures that only validated and relevant information is exchanged, maintaining system reliability and efficiency.

Further, the method and system is advantageous as it enables non-disruptive updates to LPs through a controlled submission mechanism to the external repository. This capability ensures continuous system operation while preserving valuable learning outcomes.

Yet another advantage of the method and system is that it provides a modular architecture that enables targeted optimization of LPs. This architectural approach allows for efficient resource utilization and focused improvement of domain-specific capabilities.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skills in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A machine learning system, comprising:
a processor;
at least one non-transitory memory storing instructions that, when executed by the processor, configure the machine learning system to:
obtain, from an external repository maintaining a plurality of Learning Processes (LPs), a set of domain-specific LPs, wherein each LP of the external repository is associated with at least one domain-specific knowledge graph representing learned parameters, patterns and processing capabilities for that LP;
receive operational data;
generate, from the received operational data, at least one pattern representation;
identify one or more relevant LPs from the set of domain-specific LPs by matching the at least one pattern representation with the at least one domain-specific knowledge graph;
execute the identified one or more relevant LPs to generate execution results;
detect, during execution, contradictions between the execution results and existing domain knowledge;
validate the execution results through contradiction resolution;
update the one or more LPs of the one or more relevant LPs and their associated domain-specific knowledge graphs, and trust relationships between LPs based on validation outcomes; and
enable submission of the updated one or more LPs and their associated domain-specific knowledge graphs to the external repository.

2. The machine learning system of claim 1, wherein each knowledge graph in the external repository serves as a searchable index for LP discovery and an interface definition specifying LP capabilities.

3. The machine learning system of claim 1, wherein identifying the one or more relevant LP comprises:
generating a graph distance metric between the at least one pattern representation and the domain-specific knowledge graphs; and
selecting the one or more relevant LPs based on the generated graph distance metric.

4. The machine learning system of claim 1, wherein submission of the updated one or more LPs triggers:
updating searchable indices and knowledge graphs in the external repository;
modifying interface definitions and processing capabilities; and
maintaining version history of the LPs.

5. The machine learning system of claim 1, wherein the LPs evolve independently through:
adaptation of internal models based on the validated results; and
modification of knowledge exchange patterns based on operational accuracy.

6. The machine learning system of claim 1, wherein validating the execution results comprises:
performing regression testing against historical execution results;
detecting contradictions with the existing knowledge; and
adjusting the trust relationships based on contradiction resolutions.

7. The machine learning system of claim 1, wherein updating the one or more identified LPs comprises:
removing invalidated knowledge;
adjusting learning parameters based on the validation outcomes; and
modifying knowledge exchange protocols.

8. The machine learning system of claim 1, wherein each LP maintains and adapts inbound trust circles for knowledge acceptance and outbound trust circles for knowledge distribution based on operational performance.

9. The machine learning system of claim 8, wherein the trust circles are modified based on at least one of operational validation outcomes, contradiction resolution results and principal-directed modifications.

10. The machine learning system of claim 8, wherein the trust circles control acceptance of knowledge from other LPs and distribution of knowledge to other LPs.

11. The machine learning system of claim 1, wherein the external repository maintains at least one of template graph patterns for LP discovery, operational performance metrics for each LP, and historical trust relationships between LPs.

12. The machine learning system of claim 1 is further configured to:
process operational data inputs received less than one millisecond apart;
execute the identified one or more LPs within one millisecond of receiving the operational data; and
maintain temporal order of the processed operational data for regression testing.

13. A method for implementing continuous machine learning in a computer system, the method comprising:
obtaining, from an external repository maintaining a plurality of Learning Processes (LPs), a set of domain-specific LPs, wherein each LP of the repository is associated with at least one domain-specific knowledge graph representing learned parameters, patterns and processing capabilities for that LP;
receiving operational data;
generating, from the received operational data, at least one pattern representation;
identifying one or more relevant LPs from the set of domain-specific LPs by matching the at least one pattern representation with the at least one domain-specific knowledge graph;
executing the identified one or more relevant LPs to generate execution results;
detecting, during execution, contradictions between the execution results and existing domain knowledge;
validating the execution results through contradiction resolution;
updating the one or more relevant LPs of the identified one or more relevant LPs and their associated domain-specific knowledge graphs, and trust relationships between LPs based on validation outcomes; and
enabling submission of the updated one or more LPs and their associated domain-specific knowledge graphs to the external repository.

14. The method of claim 13, wherein identifying the one or more relevant LP comprises:
generating a graph distance metric between the at least one pattern representation and the domain-specific knowledge graphs; and
selecting the one or more relevant LPs based on the generated graph distance metric.

15. The method of claim 13, wherein validating the execution results comprises:
performing regression testing against historical execution results;
detecting contradictions with the existing domain knowledge; and
adjusting the trust relationships based on contradiction resolutions.

16. The method of claim 13, wherein updating the identified one or more relevant LPs comprises:
removing invalidated knowledge;
adjusting learning parameters based on the validation outcomes; and
modifying knowledge exchange protocols.

17. The method of claim 13, wherein each LP maintains and adapts inbound trust circles for knowledge acceptance and outbound trust circles for knowledge distribution based on operational performance.

18. The method of claim 17, wherein the trust circles are modified based on at least one of operational validation outcomes, contradiction resolution results and principal-directed modifications.

19. The method of claim 17, wherein the trust circles control acceptance of knowledge from other LPs and distribution of knowledge to other LPs.
